(19) United States
(12) Patent Application Publication
(10) Pub. No.: US 2003/0212582 A1
(43) Pub. Date: Nov. 13, 2003

(54) Automated consumer claim evaluation and networked database system, with automated electronic consumer contracting of meritorious legal claims and automated consumer rejection and malpractice avoidance system for non-meritorious legal claims

(76) Inventor: Dana B. Taschner, Reno, NV (US)

Correspondence Address: SANFORD ASTOR, SANFORD ASTOR, SUITE 200, 10507 WEST PICO BLVD., LOS ANGELES, CA, 90064, US

(21) Appl. No.: 10/144,875

(22) Filed: May 13, 2002

(51) Int. Cl. G06F 17/60

(52) U.S. Cl. 705/4

(57) ABSTRACT

The invention described herein is a computerized and network-based method and system that automates the process of evaluating the merits of a consumer's legal claim, and based on the evaluation concerning the merits of a legal claim, automates electronic rejection of the legal claim or electronic acceptance of the consumer's legal claim based on the E-SIGN Electronic Signatures in Global and National Commerce Act allowing for such business model and technological innovation. The system and method collects claim information from consumers who have potential product liability claims and automatically scores and evaluates their claims according to factual and medical indicators established for that specific product claim. Once a claim has been scored, the system determines whether to reject the consumer for legal representation or attempt to retain the consumer. If a consumer is marked for rejection by the system, the system automatically generates and sends to the consumer an electronic mail notifying the consumer that the law firm has decided to not to represent the consumer. If a consumer has been marked for retention, the system will automatically generate and send to the consumer, via electronic mail, an electronic contract that the consumer may digitally sign online to retain the services of the law firm.

### TECHNICAL FIELD

The present invention generally relates to providing legal services to consumers over a computer network, such as the Internet.

### BACKGROUND OF THE INVENTION

A Forbes survey of May 13, 2002 concerning the legal industry indicates that costs related to lawsuits are escalating at an unprecedented rate. According to insurance consultant Tillinghast-Towers Perrin, costs associated with processing legal claims will increase twice as fast as the economy. Forbes states “if the momentum of litigation costs cannot be slowed, it could easily, in the space of a few years, crush important parts of the economy.” Lawsuits are expensive ventures for lawyers and law firms, in significant part because of costs of operation for space, personnel and support staff. Moreover, lawsuits can have a very significant impact on the overall economy.

Prior to the Forbes survey identifying the rapid growth in number and economic scope of consumer claims, the American Bar Association (ABA) in 1996 published a survey about legal malpractice claims. The ABA survey indicated a significant upward trend in malpractice claims against lawyers, with the biggest area of claims being administrative failures, such as failure to react and failure to properly calendar. According to the ABA study, administrative errors account for more malpractice claims than any other area, and are growing. Not surprisingly, the highest number of claims made against lawyers is in the practice area of consumer claims (or personal injury claims), accounting for one-quarter of all claims against lawyers. The ABA study indicates that administrative errors cause the greatest number of malpractice claims. Among the most prevalent administrative errors are the failure to react, failure to file, procrastination, lost files, and clerical errors. The ABA study indicates that the number of legal malpractice claims may be decreased if lawyers employ improved control systems, which the ABA identifies as “the first step of any successful loss prevention program.” Without improved systems and methods, the ABA anticipates a continuing upward claim trend in legal malpractice claims, as the ABA has determined that structure and business of American law firms is at once becoming more complex, while at the same time being downsized, meaning “less intra-firm supervision, and greater responsibility for profitability.” The ABA survey observes “economic pressures may cause lawyers to over-economize and cut corners on cases, take unsuitable consumers, and delegate too much responsibility to unsupervised associates.” The ABA finds that, “new trends, such as increase in economic pressure, breakdown of intra-law firm supervision and control . . . cry out for new loss prevention programs . . . ”

According to numerous studies, consumers are increasingly using the internet to obtain health and consumer information, and to make consumer purchasing decisions. In early 2002, the Pew Internet Study estimated the number of consumers regularly visiting the internet for consumer or health information to be 110 million.

### BRIEF DESCRIPTION OF THE INVENTION

With the advent of the computer, most world governments including the United States have enacted electronic signature legislation, fostering continued extension of electronic commerce by facilitating new business models and technological innovations. The E-SIGN, Electronic Signatures in Global and National Commerce Act (15 U.S.C. Section 7001 et seq., effective Oct. 1, 2002) recognizes electronic signatures as electronic symbols or processes that attach to, or are associated with, a contra or other record, which has been executed by a person intending to execute a contract or agreement. Most states have adopted similar digital signature laws (California Uniform Electronic Transaction Act, 2001 California Senate Bill 97; Texas Uniform Electronic Transaction Act, 20021 Texas House Bill 1201 and 2001 Texas Senate Bill 393; Florida Uniform Electronic Transaction Act, Florida Statute Section 668.50) making digital signatures generally applicable to all communications and any transactions.

The recent enactment of the Electronic Signatures in Global and National Commerce act established new law and procedures that clarify the legal status of electronic signatures, electronic contracts and electronic records in the context of writing and signing contracts under federal and state law. The E-SIGN Act regulates transactions in interstate and foreign commerce and allows for an entirely new way of contracting for businesses and consumers. Under the E-SIGN Act, an “electronic signature” is defined as “an electronic sound, symbol or process attached to or logically associated with a contact or other record and executed or adopted by a person with the intent to sign the record.” By defining electronic signature broadly, computer or telephone keypad agreements (e.g., “click here to agree” on a computer or “press 9 to agree or 5 to hear this menu again”) and click wrap agreements are now considered legally enforceable electronic contacts under the E-SIGN Act. The E-SIGN Act does not require a party to use or accept electronic signature or electronic contacts but rather seeks to facilitate the use of electronic innovations and instruments by upholding their legal effect regardless of the type or method selected by the signatories. The E-SIGN Act is technology-neutral and does not require a specific type or method that businesses and consumers must use or accept, in order to consult their electronic transaction or agreement.

Under the E-SIGN Act, a consumer may acknowledge or respond affirmatively to an electronic query to engage a law firm or lawyer on specified terms, in a consumer or legal claim. The E-SIGN Act provides a legal and commercial basis for businesses, law firms and consumers to contract and conduct transactions electronically. The E-SIGN Act facilities new business model inventions and technological innovations, such as the subject of this invention for automated analysis of legal claims, and automated acceptance of meritorious legal claims or automated rejection of non-meritorious consumer legal claims. Following the acceptance or rejection of a claim, the invention provides a database concerning claims rejected as a record for claim management and malpractice avoidance.

### BRIEF DESCRIPTION OF THE DRAWINGS

FIG. 1 is a flow chart describing the claim information gathering, evaluation, and retention and rejection process.

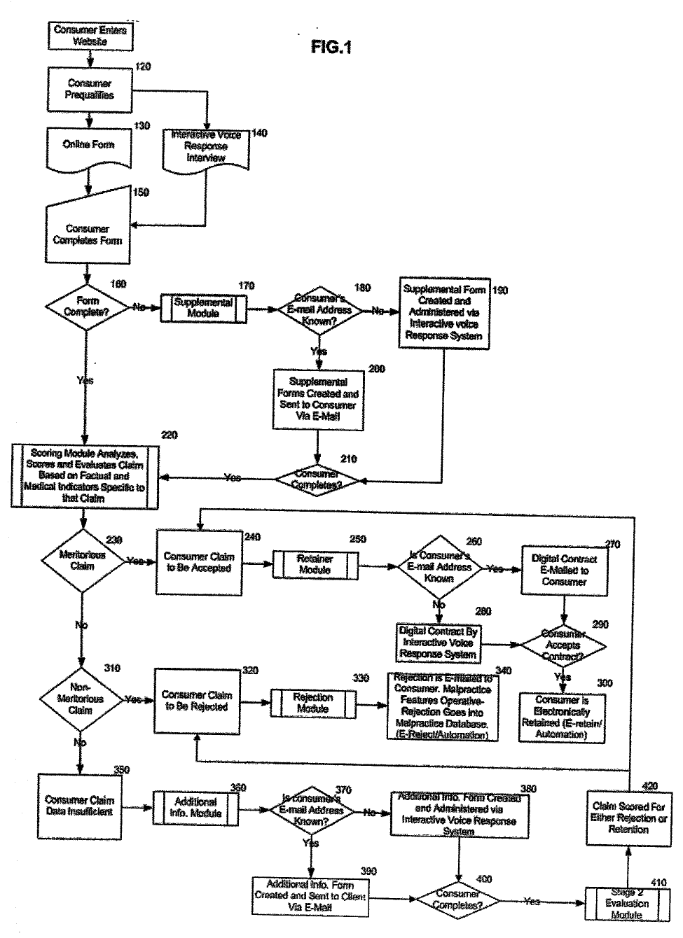

### DETAILED DESCRIPTION OF THE INVENTION

The invention described herein is a computerized and network-based method and system that electronically automates the process of evaluating the merits of a consumer's legal claim, and based on the evaluation concerning the merits of a legal claim, automates electronic rejection of the legal claim or electronic acceptance of the consumer's legal claim, based on the E-SIGN Electronic Signatures in Global and National Commerce Act, allowing for such business model and technological innovation.

The system and method collects claim information from consumers who have potential consumer legal claims, such as personal injury, product liability, tort and other plaintiff or consumer claims and automatically scores and evaluates their claims according to factual and medical indicators established for that specific consumer legal claim. Once a claim has been scored, the automated system determines whether to reject or accept the consumer legal claim. If a consumer legal claim is rejected by the system, the system automatically and promptly generates and sends to the consumer an electronic rejection notice advising and memorializing the rejection by the system operator. If the consumer legal claim is to be accepted, the system will automatically generate and send to the consumer, via electronic mail, an electronic contract that the consumer may digitally sign online to retain the services of the law firm.

The computer and network technologies and modules contained in the present invention are described in terms such that their construction and implementation would not pose a serious burden on one ordinarily skilled in the art. Furthermore, the invention described herein refers to just some of the particular embodiments. However, no limitation of the scope of the invention is thereby intended. Any alterations and modifications in the described system and method, and any applications of the principles of the invention as described herein are contemplated as would normally occur to one skilled in the art to which the invention relates.

The system partly comprises a networked computer. The system additionally comprises a consumer database that stores and indexes consumer information received, an automated interactive voice response system linked to the consumer database, and a number of computer program modules that perform various tasks as described herein below.

The automated system electronically pre-qualifies, interviews, evaluates, and screens potential legal claims by consumers. This is achieved through websites that educate consumers about one or more types of consumer claims. A website will prompt a response from visiting consumers who believe they may have a legal claim to complete an online form. The online form asks the consumer to enter their name, contact information, and answer a series of questions designed to solicit quantifiable factual and medical information enabling the automated system to evaluate and assess the merits of the legal claim. Most of the questions are in simple true/false or multiple-choice format making the data received easily quantifiable and assessable for purposes of merit evaluation. A part of the form may include a comment box in which a consumer may enter additional, non-quantifiable information potentially relevant to their prospective legal claim. The forms submitted electronically are evaluated, recorded, stored, and indexed in the system's consumer database.

Alternatively, consumers may answer the same questions contained on the form via telephone by calling a toll free number listed on the website(s). Consumers making telephonic contact are connected to an automated interactive voice response system mated with the network and database system. The interactive voice response system is an automated system that uses an electronic or recorded voice to administer the form. The interactive voice response system prompts the consumer to answer the same questions contained in the online form in multiple choice or true/false format. The consumer answers questions by pressing a number on the numeric keypad on the telephone as directed. Information is gathered and recorded using voice recognition technology. The interactive voice response system is directly linked to the consumer database and stores consumer responses. Consumers not desirous of answering questions using the interactive voice response system are informed of the option of transferring the call to a live call center operator who will administer the form. Live operators who administer forms, enter consumer's information into the same networked system as if the form was completed online or through the interactive voice response.

The system also comprises a means of effectively obtaining missing or inadequate consumer claim information so as to create a complete consumer profile. This process is tantamount to administering a supplemental or second interview. The system uses a supplemental module that automatically determines when a consumer prematurely exits before fully completing the online form or prematurely exists the telephone interactive voice response interview before the consumer has completed the automated form or automated interview, or who fails to provide sufficient information so as to enable the system to properly evaluate the claim(s). The supplemental module generates a series of questions for every such consumer. The supplemental module repeats those questions previously posed to the consumer, or adds additional determinative questions to be completed by the consumer, to allow for determination of rejection or acceptance of their legal claim(s).

Depending on the contact information that the consumer provided in the initial form, the supplemental module will attempt to contact and administer the form in one of several ways. If the consumer has provided his electronic mail address the supplemental module will automatically generate and send an electronic mail containing the supplemental form to the consumer. The electronic mail form may be completed and submitted online. Alternatively, the consumer may submit the answers via telephonic methods. If the consumer completes the electronic supplemental form and submits it via electronic mail, the system upon receipt will automatically analyze the electronic mail and record the responses in the consumer database. If within a period of time specified by the system operator, the system does not receive a reply or receives incomplete responses from a consumer who has been electronically mailed a supplemental form, the supplemental module will generate and send to the consumer additional supplemental forms. Additional electronic mail forms will be automatically sent to the consumer at a rate defined by the system operator until the system either detects that all necessary information has been collected or that the maximum number of electronic mail supplemental attempts has been reached, as defined by the system operator.

If the consumer's electronic mail address is unknown, or attempts to complete the form by electronic mail are unsuccessful, the supplemental module will attempt to administer supplemental questions by interactive voice response system if the consumer's telephone number is known. The interactive voice response system directly routes and records the responses in the consumer database. The interactive voice response system will repeatedly attempt to contact and administer the supplemental questions to the consumer, at a rate defined by the system operator, until either the system detects that all required information has been collected or the maximum number of attempts, as defined by the system operator, has been reached.

In one alternative embodiment of the invention the interactive voice response system will be used concurrently with electronic mail attempts, if both the consumer's telephone and electronic mail addresses are known. In yet another embodiment, the interactive voice response will be used prior to electronically mailed supplemental forms.

If the interactive voice response system is unsuccessful, a live call center operator will make several attempts to contact the consumer. If consumer is reached the operator will administer the form via the telephone or by facsimile transmissions. In either case the operator manually enters the information into the consumer database.

If both the consumer's telephone number and electronic mail address are unknown, or if electronic mail, voice response, and live operator attempts have proven unsuccessful, the system will, as a final resort, generate a hard copy of the supplemental form, which will be mailed to the consumer. The consumer may choose to mail back the completed form or send it by facsimile.

The system further comprises a claim-scoring module. The claim-scoring module automatically and immediately detects and analyzes completed consumer forms, and utilizing a set of rules based on factual and medical indicators and criteria established for each specific type of claim, assigns each consumer a score. The claim-scoring module then divides consumers into three categories, based on their assigned scores: 1) consumers with meritorious claims, 2) consumers with non-meritorious claims and 3) consumers whose claim data is insufficient for a proper evaluation.

The following example is a sample form that has been used for consumer injury claims related to the product known as aspirin. Included in the example is the scoring methodology, and weighting of responses, used for consumer claims.

Question 1: Have you taken a liver function test? True/False

If consumer answers true, the response is assigned 10 points.

Question 2: Have you had discolored or dark urine? True/False

If consumer answers true, the response is assigned 20 points.

Question 3: Have you had jaundice (yellowing of the eyes)? True/False

If consumer answers true, the response is assigned 20 points.

Question 4: Have you experienced stomach pain? True/False

If consumer answers true, the response is assigned 10 points.

Question 5: Have you experienced nausea? True/False

If consumer answers true, the response is assigned 10 points.

Question 6: Have you had loss of appetite? True/False

If consumer answers true, the response is assigned 10 points.

Question 7: Have you been diagnosed or treated? True/False

If consumer answers true, the response is assigned 10 points.

Question 8: Have you experienced other problems? True/False

If consumer answers true, the response is assigned 10 points.

Question 9: Other comments:

Question 9 is box where consumer may enter comments. The information entered in the box is not subject to automated scoring. Rather, the comments are used for manual review and evaluation.

The example provided above is based on a 100 point scoring system where if the total score is 50 or higher, the consumer receives an automated contract for acceptance of their consumer claim, to which the consumer may agree by electronic signature. If the completed form is scored at 10 or less, the consumer is rejected, and if the total score is between 10 and 50, the consumer is administered the Additional Information Form described herein below, and reevaluated.

The system further comprises an automated Additional Information Form module. This module, upon detecting a claim requiring additional information, automatically generates an additional form with additional questions asking the consumer for additional details regarding the claim. Depending on the contact information that the consumer provided in the initial form, the module will attempt to contact and administer the form in one of several ways. If the consumer has provided his electronic mail address, the module will automatically generate and send an electronic mail containing the Additional Information Form to the consumer. The electronically mailed Additional Information Form may be completed and submitted online. Alternatively, the consumer may submit the answers via telephone. If the consumer completes the Additional Information Form and submits it via electronic mail, the system upon receipt will automatically analyze the electronic mail and record the responses in the consumer database for purposes of evaluating whether to accept or reject the consumer's legal claim. If within a period of time specified by the system operator, the system does not receive a reply or receives incomplete responses from a consumer who has been electronically mailed an Additional Information Form, the module will generate and send to the consumer other Additional Information Forms. Additional Information Forms will be automatically sent to the consumer at a rate defined by the system operator until the system either detects that all necessary information has been collected or that the maximum number of electronically mailed Additional Information Form attempts has been reached, as defined by the system operator. The system may be programmed to automatically reject the consumer's claim by lapse of time or consumer failure to respond for additional information.

If the consumer's electronic mail address is unknown or attempts to complete the Additional Information Form by electronic mail are unsuccessful, the module will attempt to administer the Additional Information Form by interactive voice response system, if the consumer's telephone number is known. The interactive voice response system directly routes and records the responses in the consumer database. The interactive voice response system will attempt to contact and administer the Additional Information Form to the consumer, at a rate defined by the system operator, until either the system detects that all required information has been collected or the maximum number of attempts, as defined by the system operator, has been reached, for purposes of evaluating automated acceptance or rejection of the consumer's legal claim.

In one alternative embodiment of the invention the interactive voice response system will be used concurrently with electronic mail attempts if both consumer's telephone and electronic mail addresses are known. In yet another embodiment, the interactive voice response will be used prior to electronically mailing the Additional Information Form.

If the interactive voice response system is unsuccessful, a live call center operator may be notified by the system to make manual attempt to contact the consumer. If the consumer is reached by manual attempt, the live operator will administer the electronic form via the telephone or by facsimile transmissions. In either case the live operator manually enters the information into the automated consumer database, which processes and evaluates the consumer information for automated acceptance or rejection.

If both the consumer's telephone number and electronic mail address are unknown, or if electronic mail, voice response, and live operator attempts have proven unsuccessful, the system will, as a final resort, generate and mail a copy of the Additional Information Form to the consumer's physical address The consumer may choose to mail back the completed form or send it by facsimile.

When the system detects that the completed Additional Information Form has been received, a reevaluation module analyzes and scores the responses in the manner described above. Based on the Additional Information Form score, the consumer is either marked for immediate retention or rejection.

In addition to administering the Additional Information Form, the law firm or system operator may manually review and evaluate a consumer's claim that is marked reevaluation.

The system further comprises an automated rejection notification module. This module, upon detecting a non-meritorious claim, automatically and generates and sends an electronic mail to the consumer informing them that the system operator declines to represent the consumer, and provides the consumer with an automated rejection and information about the rejection of the claim, applicable statutes of limitation in the consumer's identified state. For example, a rejected consumer identifying California as their place of residence receives a rejection notice containing information about the California One Year Statute of Limitations for consumer legal claims (personal injury, product liability or other consumer legal claims) and that legal claims must be filed within the statutory period or rights will be lost, and that the consumer should immediately seek legal counsel should they desire to preserve their legal rights, and that the consumer should consult a medical or health care professional concerning medical or health questions or concerns.

The system automatically records in the consumer database that the rejection notice was sent to the prospective plaintiff in a timely manner. If the rejected consumer's electronic mail address is unknown the consumer will be notified by electronic telephone system or conventional mail.

The system further comprises an automated retainer module. This module, upon detecting a consumer with a meritorious claim, automatically generates and sends to the consumer via electronic mail, an electronic contract for the consumer to digitally sign online to retain the services of the system operator. The digital retainer is a standard contract in a conventional electronic mail format that may be received and read by the consumer using any standard electronic mail interface. The digital contract contains a single-action consumer acceptance interface. In the currently preferred embodiment, the acceptance interface in the form of a graphical button or icon containing the text “I accept” located at the end of the contract. In such an embodiment the consumer digitally signs the retainer by simply moving their computer mouse cursor over the button or icon and pressing the mouse button. When a consumer accepts the digital retainer, notice of the acceptance is electronically routed to law firm's server system and the details of the acceptance, including the date, exact time, and computer address of the consumer.

If the electronic mail address of a consumer with a meritorious claim is unknown, the automated retainer module will contact the consumer through the interactive voice response system. The interactive voice system will contact the consumer and the interactive electronic voice response system will recite the terms of the retainer to the consumer and instruct the consumer to press a specified button on the consumer's telephone keypad to accept the contract. When the consumer presses the accept button, notice of the acceptance is electronically confirmed and recorded in the consumer database.

If neither the electronic mail address nor telephone number of a consumer with a meritorious claim is known the system will print a hard copy of the retainer, which will be mailed to the consumer's physical address.

Referring now to the drawing there is shown step 110 where the consumer enters the website. In step 120 the consumer pre-qualifies by the nature of the consumer's visit and submission of the online form. The automated system identifies the website and form submitted by the consumer and categorizes the consumer inquiry and form. For example, a consumer who visits www.AspirinAlert.com, will complete a form on that website. The system recognizes the form as generated online by a consumer visiting www.AspirinAlert.com website, which prompts the consumer visitor to the www.AspirinAlert.com website to complete the online www.AspirinAlert.com form if the consumer has used the aspirin product, the consumer has experienced health problems or injury, and the consumer desires to consult a legal professional about the consumer's health problems or injury related to the aspirin product. These query prompts pre-qualify the consumer for evaluation by the automated system. The consumer then can complete an online form 130 or an interactive voice response interview 140. When the consumer has completed the form, either way, 150, the system determines if the form is complete 160. If not, the supplemental module 170 sends to the consumer's e-mail address 180 a supplemental form 200 or sends it via an interactive voice response system 190.

When the consumer completes the supplemental form, 190, 200, 210, it is sent to a scoring module 220. If the consumer completes the form completely in the first instance 160, it is sent directly to the scoring module 220. If the scoring module 220 calculates a meritorious claim 230 the consumer claim is accepted 240, the retainer module creates a retainer agreement. If the consumer's e-mail address is known 260 a digital retainer agreement is e-mailed to the consumer 270. The consumer may accept it 290 and the consumer is electronically retained 300.

If the consumer e-mail address is not known the consumer may be contacted by an interactive voice response system 280 where the retainer can be accepted 290, 300.

If the scoring module determines that the claim is non-meritorious 310, the consumer claim is rejected 320, 330, a rejection is e-mailed to the consumer 340 and the rejection also goes to the malpractice database.

If the consumer data is insufficient 350 additional information is needed 360. If the e-mail address is known 370 an additional information form is sent to the consumer 390. If the consumer completes the additional information form 400 it is scored 410 for acceptance or rejection 420 which is transmitted as set forth above. If the e-mail address is not known, the additional information form may also be sent to the consumer by interactive voice response 380 and then sent as previously set forth above.

As can be seen, the entire system is electronically automated. A separate series of questions is created for each legal claim based upon the specific nature of the claim involved.

Having thus described the invention, I claim:

1: A computerized and network-based system that automates the process of evaluating the merits of a consumer's legal claim, and based on the evaluation concerning the merits of a legal claim, automates electronic rejection of the legal claim or electronic acceptance of the consumer's legal claim, comprising collecting specific claim information from consumers who have potential legal claims and automatically scoring and evaluating their claims according to factual indicators established for a specific type of claim.

2: The system of claim 1 comprising an internet website available for online connection by consumers, said website having consumer legal claim information, a separate questionnaire for the consumer to complete for each legal claim on the website, if the consumer feels that he has a legal claim listed on the website, a module for determining whether the questionnaire has been completed or not, if the questionnaire has been completed, a scoring module to determine a score based on the consumer's answers to the questionnaire, and a supplemental module to send a supplemental questionnaire to the consumer if he has failed to complete the first questionnaire.

3: The system of claim 2 in which the website legal claims comprise, personal injury, product liability or tort claims.

4: The system of claim 2 in which a retainer agreement is automatically sent to the consumer to sign electronically if the score is above a predetermined number and an electronically generated rejection letter is automatically sent to the consumer if the score is below a predetermined number.

5: The system of claim 4 in which the retainer agreement or rejection is promptly sent by e-mail.

6: The system of claim 4 in which the retainer agreement or rejection is promptly sent by a telephone voice response system.

7: The system of claim 4 in which a supplemental questionnaire is sent to any consumer whose score falls between the acceptance and rejection scores.

8: The system of claim 5 in which acceptance of the retainer agreement is accomplished by the consumer clicking a mouse on an icon, symbol or text on the agreement.

9: The system of claim 6 in which acceptance of the retainer agreement is accomplished by the consumer pressing a specific keypad button on his telephone.

10: The system of claim 4 comprising means to electronically automate recordation of the consumer's electronic, telephonic or physical address and the date and time that a rejection is sent to the consumer.

11: The system of claim 2 in which the consumer is contacted by a live operator in the event the consumer cannot be contacted by e-mail or by a telephone voice response system.

12: A computerized and network-based system that automates the process of evaluating the merits of a consumer's product liability legal claim, and based on the evaluation concerning the merits of the legal claim, automates electronic rejection of the legal claim or electronic acceptance of the consumer's legal claim, comprising collecting specific claim information from consumers who have potential product liability claims and automatically scoring and evaluating their claims according to factual and medical indicators established for a specific product claim said system comprising, an internet website available for online connection by consumers, said website having product liability information about one or more products, a separate questionnaire for the consumer to complete for each product on the website, if the consumer feels that he has been injured by one of the products listed on the website, a module for determining whether the questionnaire has been completed or not, if the questionnaire has been completed, a scoring module to determine a score based on the consumer's answers to the questionnaire, and a supplemental module to send a supplemental questionnaire to the consumer if the first questionnaire has not been completed.

13: The system of claim 12 in which the website comprises recalled products.

14: The system of claim 12 in which a retainer agreement is automatically sent to the consumer to sign electronically if the score is above a predetermined number and a rejection letter is automatically sent to the consumer if the score is below a predetermined number.

15: The system of claim 12 in which the retainer agreement or rejection is sent by e-mail.

16: The system of claim 12 in which the retainer agreement or rejection is sent by a telephone voice response system.

17: The system of claim 12 in which a supplemental questionnaire is sent to any consumer whose score falls between the acceptance and rejection scores.

18: The system of claim 14 in which acceptance of the retainer agreement is accomplished by the consumer clicking a mouse on an icon on the agreement.

19: The system of claim 14 in which acceptance of the retainer agreement is accomplished by the consumer pressing a specific button on his telephone.

20: The system of claim 14 comprising means to record the date and time that a rejection is sent to the consumer.
